(19) United States
(12) Patent Application Publication
(10) Pub. No.: US 2020/0063906 A1
(43) Pub. Date: Feb. 27, 2020

(54) DRILLING DEVICE AND DRILLING METHOD

(71) Applicant: SHONAN GOSEI-JUSHI SEISAKUSHO K.K., Hiratsuka-shi (JP)

(72) Inventors: Takao KAMIYAMA, Hiratsuka-shi (JP); Takashi KATO, Tokyo (JP)

(21) Appl. No.: 16/492,887

(22) PCT Filed: Feb. 21, 2018
(86) PCT No.: PCT/JP2018/006169

§ 371 Date: Sep. 10, 2019

(30) Foreign Application Priority Data
Mar. 15, 2017 (JP) 2017-050336
Apr. 25, 2017 (JP) 2017-086686

(51) Int. Cl. F16L 41/04; B26D 5/02; B26F 1/16; F16L 55/18

(52) U.S. Cl. CPC F16L 41/04; F16L 55/18; B26F 1/16; B26D 5/02

(57) ABSTRACT

A drilling apparatus includes a hydraulic motor 27 for rotating a drilling blade 30 that drills a pipe lining material 13, laser light sources 40, 41 for emitting laser beams toward the pipe lining material parallel to the rotary shaft of the drilling blade from positions near the drilling blade to form laser spots on the inner circumferential surface of the pipe lining material, an electric motor 28 for rotating the laser light sources coaxially with the rotary shaft of the drilling blade, and a camera 50 for photographing the trajectory of the laser spots rotating on the inner circumferential surface of the pipe lining material and a bright area that is formed on the inner circumferential surface of the pipe lining material by illumination light from the lateral pipe side. The positioning of the drilling blade is performed so that the trajectory image and the bright area image match.

### TECHNICAL FIELD

The present invention relates to a drilling apparatus and drilling method in which a pipe lining material that blocks a lateral pipe opening is drilled from the main pipe side.

### BACKGROUND ART

When an existing pipe such as a sewer pipe buried underground has deteriorated, a lining method has been conventionally known in which the existing pipe is lined with a pipe lining material. The pipe lining material includes a resin absorbing material that is made of a flexible tubular non-woven fabric having a shape corresponding to that of the existing pipe and is impregnated with an uncured liquid setting resin. The resin absorbing material is coated at its external peripheral surface with a highly airtight plastic film. The pipe lining material is inserted into the existing pipe by means of an eversion or pull-in method. The pipe lining material is pressed against the internal circumferential surface of the existing pipe, and the liquid setting resin is heated and cured to carry out the lining.

Since a lateral pipe communicates with a main pipe such as a sewer pipe, the pipe lining material blocks the opening at the end of the juncture of the lateral pipe when the main pipe is lined with the pipe lining material. Therefore, a work robot provided with a drilling machine and a TV camera is transported into the main pipe and operated remotely from aboveground. While monitoring an image taken with the TV camera, an operator positions the rotation center of the cutter (drilling blade) of the drilling machine to the center of the lateral pipe opening, and drills the pipe lining material at the lateral pipe opening from the main pipe side.

However, in this work, the cutter of the drilling machine must be positioned respectively in the longitudinal direction and in the circumferential direction of the main pipe. This is accomplished while monitoring the main pipe interior with the TV camera. However, since there is no marker in the main pipe interior, there are cases in which mistakes are made in positioning.

As a countermeasure, the following Patent Document 1 discloses an arrangement in which a plurality of laser beam emitters each emitting a laser beam toward the direction of the drilling cutter is provided in symmetrical positions about the rotation center of the cutter to emit a laser beam toward the pipe lining material at the lateral pipe opening at the time of drilling in order to position the cutter.

Furthermore, various methods of positioning the cutter are known. For example, the following Patent Document 2 describes an arrangement in which a marker is provided in advance at the center of the lateral pipe opening or at a position corresponding thereto and, after lining the main pipe, the marker position is detected by a sensor to determine the center of the lateral pipe opening and perform the cutter positioning.

### PRIOR ART DOCUMENTS

### Patent Documents

Patent Document 1: JP 2000-97388 A

Patent Document 2: JP 1995-88915 B

### SUMMARY OF INVENTION

### Problems to be Solved

At the time of drilling, illumination light from the side of the lateral pipe passes through the pipe lining material that blocks the lateral pipe opening. This causes a bright area corresponding to the lateral pipe opening to be formed at the inner circumferential surface of the pipe lining material of the main pipe. In the arrangement in Patent Document 1, the laser beam emitters are arranged so as to be immovable relative to the cutter, so that the position of the laser beam at the pipe lining material that is emitted toward the pipe lining material doesn't change even if the cutter rotates. Therefore, the operator can only observe a state in which multiple bright spots are discrete and do not move near the bright area.

The positioning of the cutter is accomplished such that the rotation center of the cutter coincides with the center of the bright area that corresponds to the lateral pipe opening. Therefore, the rotation center of the cutter is estimated at the time of drilling from the above-mentioned multiple bright spot positions and the center of the bright area is also estimated by observation. This makes the positioning to be inaccurate, causing a problem that it was difficult to perform efficient drilling.

In the arrangement in Patent Document 2, the positioning accuracy of the cutter depends on the mounting accuracy of the marker. Positioning errors further occur when the cutter is moved to the detected drilling position, and this may not always result in the desired drilling. It is difficult to detect the mounting errors of the marker and the positioning errors of the cutter. In the case of drilling performed on the premise that there are no such errors, there would be a problem that accurate drilling cannot be guaranteed.

It is therefore an object of the present invention to solve such problems and provide a drilling apparatus and a drilling method being capable of efficiently and without drilling errors cutting the pipe lining material that blocks the lateral pipe opening.

### Means for Solving the Problems

The present invention relates to a drilling apparatus in which a pipe lining material that blocks a lateral pipe opening is drilled from the main pipe side by rotating a drilling blade comprising:

a robot that moves in the pipe-length direction inside the main pipe;

a drilling blade mounted on the robot;

a motor for rotating the drilling blade;

a laser light source disposed in the vicinity of the drilling blade for emitting a laser beam parallel to the rotary shaft of the drilling blade to form a laser spot on the inner circumferential surface of the pipe lining material;

a camera mounted on the robot for photographing a trajectory of the laser spot that is drawn on the inner circumferential surface of the pipe lining material by rotating the laser light source coaxially with the rotary shaft of the drilling blade, and a bright area corresponding to the lateral pipe opening that is formed on the inner circumferential surface of the pipe lining material by illumination light from the lateral pipe side; and

positioning means for positioning the drilling blade so that the trajectory image of the laser spot photographed by the camera matches the bright area image corresponding to the lateral pipe opening.

The present invention further relates to a drilling method in which a pipe lining material that blocks a lateral pipe opening is drilled from the main pipe side by rotating a drilling blade comprising:

illuminating the lateral pipe opening from the lateral pipe side;

emitting a laser beam from a laser light source toward the pipe lining material in a direction parallel to the rotary shaft of the drilling blade from a position near the drilling blade to form a laser spot on the inner circumferential surface of the pipe lining material;

moving the drilling blade to the position of a bright area corresponding to the lateral pipe opening that is formed on the inner circumferential surface of the pipe lining material by illumination light from the lateral pipe side while rotating the laser light source coaxially with the rotary shaft of the drilling blade;

photographing the trajectory of the laser spot that is drawn on the inner circumferential surface of the pipe lining material in accordance with rotation of the laser light source and the bright area corresponding to the lateral pipe opening; and

drilling by positioning the drilling blade so that the trajectory image of the photographed laser spot matches the bright area image corresponding to the lateral pipe opening.

### Effect of the Invention

In the present invention, the laser spot formed on the inner circumferential surface of the pipe lining material rotates thereon around the rotary shaft of the drilling blade and moves along a portion where the drilling blade actually cuts the pipe lining material. The rotating laser spot and the bright area corresponding to the lateral pipe opening are photographed, and the drilling blade is positioned so that the trajectory image of the photographed laser spot matches the bright area image. This allows the drilling blade to be accurately moved to the position of the lateral pipe opening, making possible efficient drilling with few drilling errors.

### BRIEF DESCRIPTION OF DRAWINGS

FIG. 1 is an illustrative view showing a configuration of a drilling apparatus that moves inside a main pipe lined with a pipe lining material;

FIG. 2a is a top view showing a drilling blade and laser light sources;

FIG. 2b is a side view showing the drilling blade and a motor for rotating the drilling blade;

FIG. 3 is a top view showing a holding plate for holding the laser light sources;

FIG. 4a is a perspective view showing a bright area that is formed corresponding to the lateral pipe opening on the inner circumferential surface of the pipe lining material by illumination light from the lateral pipe side;

FIG. 4b is a perspective view showing a movement trajectory of laser spots that is formed on the inner circumferential surface of the pipe lining material by laser beams;

FIG. 5 is an illustrative view showing a state in which a bright area image corresponding to the lateral pipe opening is matched with a trajectory image of the laser spots when the drilling apparatus advances with a correct posture toward the lateral pipe opening;

FIG. 6 is an illustrative view showing a state in which a bright area image corresponding to the lateral pipe opening is matched with a trajectory image of the laser spots when the drilling apparatus rolls forward toward the lateral pipe opening;

FIG. 7 is a top view showing a holding plate on which one laser light source is held;

FIG. 8 is a top view showing holding plates on which four laser light sources are held;

FIG. 9 is a front view showing an embodiment in which a motor for rotating the drilling blade is used to rotate the laser light sources;

FIG. 10 is a front view showing an embodiment in which the laser light sources are mounted on the outer circumferential surface of the drilling blade;

FIG. 11a is a top view showing a structure for adjusting a radial distance of the laser light sources from the rotary shaft of the drilling blade;

FIG. 11b is a side view showing a structure for adjusting a radial distance of the laser light sources from the rotary shaft of the drilling blade;

FIG. 12 is block diagram showing a configuration of a drilling blade positioning controller and a computer for controlling the controller;

FIG. 13 is a flowchart showing the steps for positioning the drilling blade;

FIG. 14 is an illustrative view showing the steps for positioning the drilling blade; and

FIG. 15 is a block diagram corresponding to FIG. 12 in which operation buttons are provided to finely adjust the position of the drilling blade.

### MODE OF CARRYING OUT THE INVENTION

The present embodiments according to the present invention will now be described with reference to the attached drawings. The embodiments are described for a case in which a sewer main pipe is illustrated as an existing pipe, and, after lining the sewer pipe with a pipe lining material, a lateral pipe opening blocked by the pipe lining material is drilled through. However, the present embodiments can be applied not only for the sewer pipe, but also for other pipelines whose openings are blocked after lining by the pipe lining material and are drilled through.

### Embodiment 1

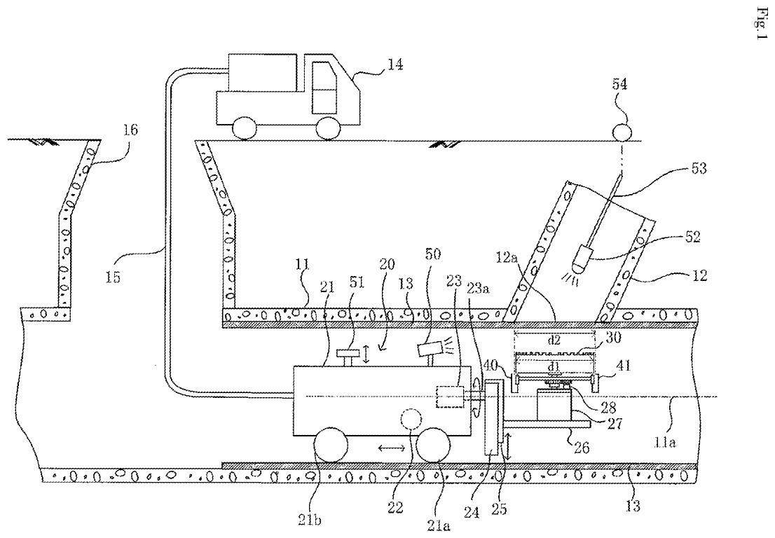

FIG. 1 shows a state in which an aged sewer main pipe 11 is lined at its inner wall surface with a pipe lining material 13 by means of an eversion or pull-in method. The pipe lining material 13 includes a resin absorbing material made of a flexible tubular non-woven fabric and impregnated with an uncured liquid setting resin. For a thermosetting resin, the pipe lining material 13 pressed against the inner surface of the main pipe is heated, while it is irradiated with UV rays for a photo-curable resin. The pipe lining material 13 is then cured to line the inner surface of the main pipe 11.

A plurality of lateral pipes 12 branch off from the main pipe 11, and sewage from homes or buildings is discharged into the main pipe 11 through the lateral pipes 12. Once the main pipe 11 is lined with the pipe lining material 13, the lateral pipe 12 which remained open at an opening 12a is blocked by the pipe lining material 13, as shown in FIG. 1. A drilling apparatus 20 cuts and drills the pipe lining material 13 that blocks the lateral pipe opening 12a.

The drilling apparatus 20 includes a robot 21 with four wheels 21a, 21b (two other wheels invisible in FIG. 1) and is transported through a manhole 16 into the main pipe 11. The transported drilling apparatus 20 is four-wheel driven by an electric motor 22 equipped with a rotational position sensor such as a rotary encoder, and is moved back and forth in the longitudinal direction of the main pipe. In the robot 21, an electric motor (servo-motor) 23 is mounted that is similarly provided with a rotational position sensor such as a rotary encoder and has a rotary shaft 23a to which a hydraulic cylinder 24 is fixed. The electric motor 23 is mounted at the center of the robot 21 as viewed circumferentially such that its rotary shaft 23a is coaxial with the pipe axis 11a of the main pipe 11 or parallel thereto. The electric motor 23 is driven to drive the hydraulic cylinder 24 in such a way that it swings about the pipe axis 11a or an axis parallel thereto.

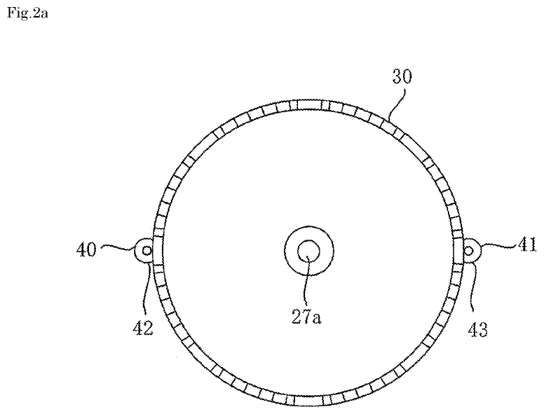

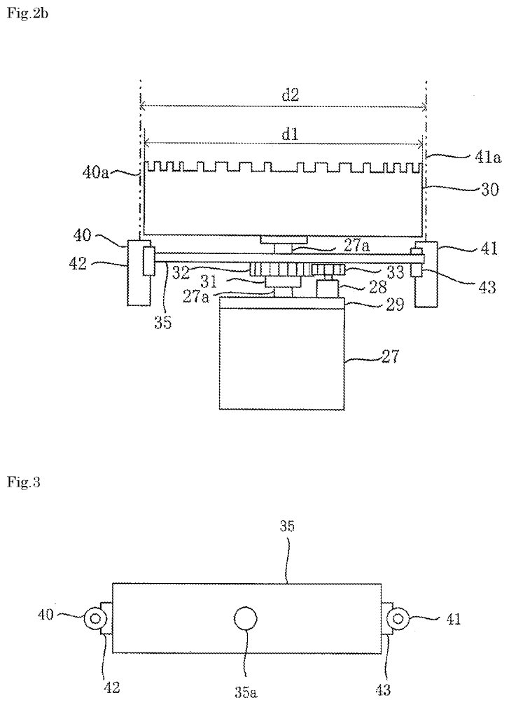

A mount 25 is fixed to the piston rod of the hydraulic cylinder 24. The mount 25 and a support plate 26 fixed thereto move up and down when the hydraulic cylinder 24 is driven. A hydraulic motor 27 is fixed to the support plate 26 and has an output shaft 27a (FIG. 2) to which a drilling blade 30 is attached that is configured as a hole saw for cutting the pipe lining material 13. Mounted on the hydraulic motor 27 is, as will be described later, an electric motor 28 that rotates laser light sources 40, 41 for emitting laser beams coaxially with the output shaft 27a of the hydraulic motor 27.

A work truck 14 is provided with a console (not shown) on which operation devices such as various kinds of switches, operation buttons, joystick and the like are arranged to move the drilling blade 30 in the longitudinal and/or circumferential directions of the main pipe. The electric motors 22, 23, the hydraulic cylinder 24, the hydraulic motor 27, the electric motor 28 and the like are driven and controlled by operations on the console via power lines and date lines inside a cable pipe. The hydraulic system for the hydraulic cylinder 24 and the hydraulic motor 27 is not shown.

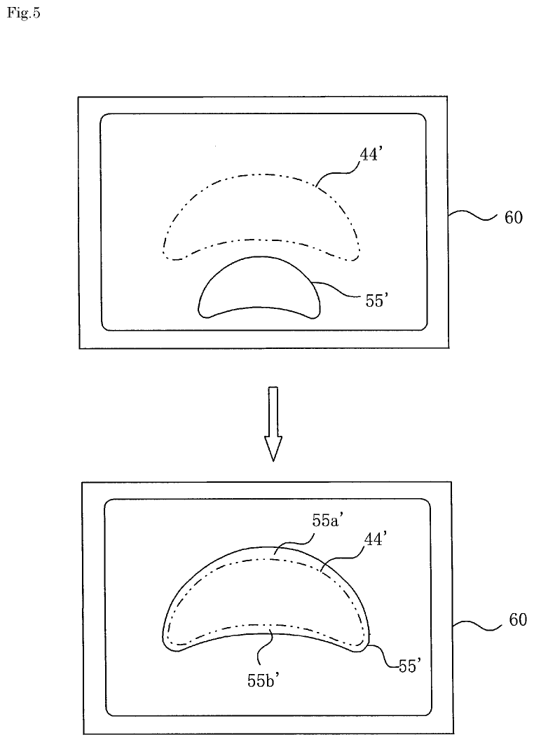

A camera 50 with a built-in image sensor made of CCD or CMOS is obliquely upward mounted on the upper portion of the robot 21 and at the center thereof as viewed in the circumferential direction of the main pipe in order to photograph the inside of the main pipe. The camera 50 has its photographing optical axis directed upward so that the trajectory image of the laser spots by the laser beams from the laser sources 40, 41 may be displayed substantially at the center of screen of a display 60 (FIG. 5) as described later. The image taken with the camera 50 is displayed on the display 60 inside the work truck 14 via a signal cable in the cable pipe 15, so that the operator can observe the main pipe interior.

The robot 21 is equipped at the top with a bracing member 51, which is lifted against the upper surface of the pipe lining material 13 in order to stabilize the robot 21 during drilling.

When drilling the pipe lining material 13, a lighting lamp 52 is introduced from the ground into the lateral pipe 12, and is lit by a power supply 54 above the ground via a power supply line 53 to illuminate from the top the pipe lining material 13 that blocks the lateral pipe opening 12a.

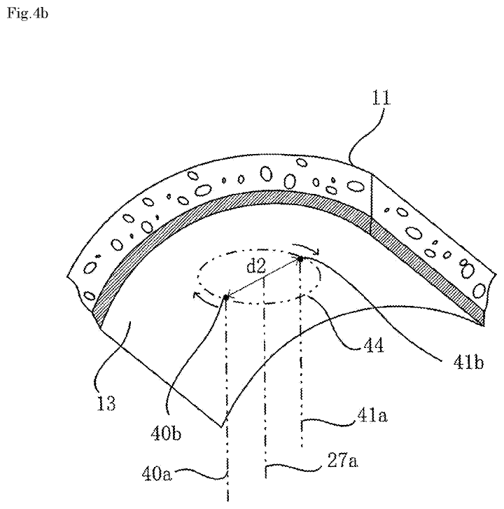

Since the pipe lining material 13 is made of a non-woven fabric, illumination light transmits through the pipe lining material 13 even if the resin impregnated therein is cured. When viewing the transmitted light from the interior of the main pipe 11, it can be observed as a bright area 55 that is curved corresponding to the inner surface of the main pipe 11, as shown in FIG. 4a. For the perpendicular intersection of the lateral pipe 12 with the main pipe 11, the bright area 55 is observed as a circular image when viewed from directly below, while for the oblique intersection therewith as shown in FIG. 1, it is observed as an elliptical image depending on its inclination.

FIG. 2a and FIG. 2b show a mechanism for rotating the drilling blade 30 and the laser light sources 40, 41. The drilling blade 30 is fixed to the distal end of the output shaft 27a of the hydraulic motor 27. The drilling blade 30 rotates about the output shaft 27a of the hydraulic motor 27 when the hydraulic motor 27 is driven.

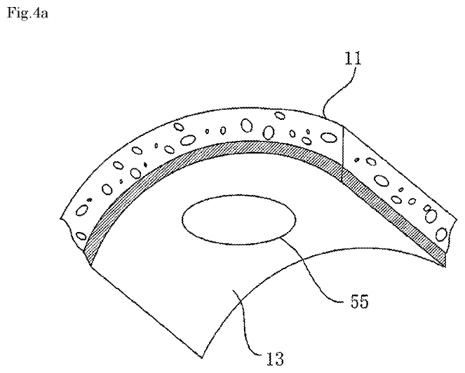

A ring 31 is fixed to the output shaft 27a of the hydraulic motor 27 and a gear 32 rotatably attached to the output shaft 27a of the hydraulic motor 27 is provided in a sitting manner at the upper portion thereof. The gear 32 meshes with a pinion gear 33 of the electric motor 28 that is mounted on a mount base 29 of the hydraulic motor 27. When the electric motor 28 is driven, the gear 32 rotates coaxially with the rotary shaft of the drilling blade 30, that is, the output shaft 27a of the hydraulic motor 27. A holding plate 35 is fixed to the surface of the gear 32 opposite the ring 31. As shown in FIG. 2b and FIG. 3, the holding plate 35 is provided at both side ends with holding brackets 42, 43 having recesses into which the laser light sources 40, 41 is pressed to hold the laser light sources 40, 41 thereto. The laser light sources 40, 41 are disposed in the vicinity of the drilling blade 30 so that laser beams 40a, 41a emitted may be parallel to the rotary shaft 27a of the hydraulic motor 27, that is, the rotary shaft of the drilling blade 30. Here, a state to be parallel to the rotary shaft of the drilling blade 30 includes not only strictly parallel but also so parallel that the trajectory drawn on the inner circumferential surface of the pipe lining material by the laser spots rotating in accordance with rotation of the electric motor 28 approximately indicates the area of the pipe lining material that is actually cut by the drilling blade, as will be described later.

A hole 35a that is formed at the center of the holding plate 35 is set to have a diameter that allows the output shaft 27a of the hydraulic motor 27 to pass therethrough. The electric motor 28 is driven to rotate the laser light sources 40, 41 held on the holding plate 35 coaxially with the rotary shaft of the drilling blade 30 independently of the drive of the hydraulic motor 27, i.e., independently of rotation of the drilling blade 30.

The laser light sources 40, 41, for example, emit the red or green laser beams 40a, 41a and are driven by a battery mounted on the holding plate 35 or a built-in battery.

The diameter d1 of the drilling blade 30 is, as shown in FIG. 1, set smaller than the diameter of the lateral pipe opening 12a so as not to damage the interior of the lateral pipe 12 during drilling the pipe lining material 13. On the other hand, the distance d2 between the optical axes of the laser beams 40a, 41a emitted from the laser light sources 40, 41 is set greater than the diameter d1 of the drilling blade 30 and equal to or smaller than the diameter of the lateral pipe opening 12a.

When the laser beams 40a, 41a emitted from the laser light sources 40, 41 are projected on the pipe lining material 13, small-diameter laser spots 40b, 41b that correspond to the cross section of the laser beams 40a, 41a are formed on the inner circumferential surface of the pipe lining material 13, as shown in FIG. 4b. When driving the electric motor 28, the laser spots 40b, 41b rotate about the rotary shaft of the drilling blade 30 (output shaft 27a of the hydraulic motor 27) on the inner circumferential surface of the pipe lining material and move along the outer circumference of the area of the pipe lining material 13 that is actually cut by the drilling blade 13. The movement trajectory of the laser spots 40b, 41b on the inner circumferential surface of the pipe lining material has a shape in which a circle having a diameter d2 is curved according to the curvature of the pipe lining material 13.

In such an arrangement, the drilling apparatus 20 is transported through the manhole 16 into the main pipe 11 that is lined with the pipe lining material 13 and is moved toward the lateral pipe opening 12a inside the main pipe 11 by driving the electric motor 22. When the laser light sources 40, 41 are activated and the electric motor 28 is driven, the laser spots 40b, 41b formed by the laser beams 40a, 41a rotate with a trajectory 44 around the rotary shaft of the drilling blade 30 on the inner circumferential surface of the pipe lining material 13, as shown in FIG. 4b.

It is now assumed that the drilling apparatus 20 moves forward inside the main pipe 11 in a normal posture at an angle where the rotary shaft of the drilling blade 30 is vertical. The camera 50 captures obliquely from below as videos the laser spots 40b, 41b rotating in accordance with rotation of the laser light sources 40, 41 and the bright area 55 corresponding to the lateral pipe opening. As shown in the upper part of FIG. 5, a trajectory image 44′ of the laser spots 40b, 41b taken with the camera 50 is displayed substantially at the screen center of the display 60.

The pipe lining material 13 is made of non-woven fabric. Therefore, when the laser beams 40a, 41a are projected on the pipe lining material 13, the laser spots 40b, 41b diffuse to diameters larger than those corresponding to the cross-sectional areas of the laser beams 40a, 41a and thus have diameters larger than the actual cross-sectional areas thereof. This makes the captured trajectory image unclear. Therefore, the images are processed to find the centers of the diffused spots, which are then combined to provide and display a trajectory image 44′. The bright area 55 corresponding to the lateral pipe opening also has a blurred outline because illumination light diffuses. Therefore, the bright area images shown in the following are also processed such that the captured bright area images have clear outlines.

When the drilling apparatus 20 reaches the vicinity of the lateral pipe opening 12a, the camera 50 can take the bright area 55 and the image 55′ thereof can be displayed at the lower screen portion on the display 60. Since the bright area 55 and the trajectory 44 of the laser spots are photographed obliquely from blow, the bright area image 55′ indicated by the solid line and the trajectory image 44′ indicated by the two-dot chain line are each displayed as a curved ellipse image.

As the drilling apparatus 20 further advances, the bright area image 55′ moves while expanding from below to above, although the trajectory image 44′ remains unchanged at the screen position. When the bright area image 55′ and the trajectory images 44′ are matched and the bright area image 55′ includes the trajectory image 44′ therein as shown in the lower part of FIG. 5, the joystick or operation button is operated to stop the electric motor 22 to position the drilling blade 30. In the specification, the matching of the bright area image 55′ and the trajectory image 44′ means that the bright area image 55′ is in a state in which the trajectory image 44′ is included therein.

Since the lateral pipe 12 obliquely intersects with the main pipe 11, the bright area image 55′ shapes into an ellipse curved with the curvature of the main pipe and is further away from the trajectory image 44′ in the upper portion 55a′ than in the lower portion 55b′, as shown in the lower part of FIG. 5. When the bright area image 55′ includes the trajectory image 44′ therein as shown in the lower part of FIG. 5, it is determined that the bright area image 55′ and the trajectory image 44′ are matched.

In this state, the hydraulic cylinder 24 is driven to move drilling blade 30 upward and the hydraulic cylinder 27 is driven to rotate the drilling blade 30. The bracing member 51 is then lifted against the pipe lining material 13 in order to stabilize the drilling apparatus. The drilling blade 30 rotates along the movement trajectory 44 of the laser spots 40b, 41b inside thereof to cut the portion of the pipe lining material that blocks the lateral pipe opening 12a. Since the bright area image 55′ and the trajectory image 44′ are matched, the drilling blade 30 cuts only the portion of the pipe lining material inside the bright area 55 and it is possible to prevent the drilling blade 30 from cutting off the portion of the pipe lining material 13 outside the bright area 55, that is, from cutting off the portion of the pipe lining material 13 beyond the lateral pipe opening 12a.

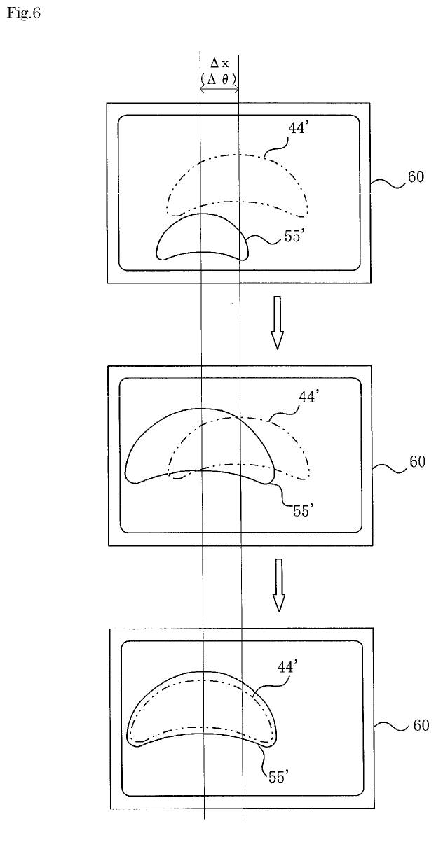

The drilling apparatus 20 does not necessarily approach the lateral pipe opening 12a in a correct posture, and is assumed to be rotated by Δθ (rolling) in the clockwise direction about the pipe axis 11a as viewed in the forward direction, for example. In this case, when the drilling apparatus 20 approaches the lateral pipe opening 12a, the trajectory image 44′ of the laser spots is displayed almost at the center of the screen of the display 60 as shown in the upper part of FIG. 6. However, the bright area image 55′ is displayed at a position deviated to the left by Δx in the horizontal direction of the screen.

When the drilling apparatus 20 further moves forward and the bright area image 55′ and the trajectory image 44′ are displayed at substantially the center of the screen as shown in the middle part of FIG. 6, the electric motor 22 is caused to stop and the electric motor 23 is rotated counterclockwise by Δθ to position the drilling blade 30 in the pipe-length and circumferential directions. This causes the rotary shaft of the drilling blade 30 and the optical axes of the laser light sources 40, 41 to also rotate counterclockwise by Δθ. As shown in the lower part of FIG. 6, the trajectory image 44′ is moved Δx to the left on the screen of the display 60 to match the bright area image 55′.

In this state, the hydraulic cylinder 24 is driven to move the drilling blade 30 upward, and the hydraulic motor 27 is driven to rotate the drilling blade 30 to cut the pipe lining material 13 that blocks the lateral pipe opening 12a. As in the case of the correct posture described above, the drilling blade 30 cuts the pipe lining material inside the movement trajectory 44 of the laser spots 40b and 41b, so that the intended drilling can be performed.

The drilling apparatus 20 may move to the drilling position in a complicated posture as well as roll about the pipe axis 11a as described above. Even in this case, the operation button or the joystick can be operated to move the drilling blade 30 in the pipe-length direction and in the circumferential direction to thereby match the bright area image 55′ with the trajectory image 44′. A part of the bright area image 55′ may protrude from the screen of the display 60 or matching cannot be performed within the allowable error range. In this case, the drilling apparatus 20 is moved backward once and the above-described operation can be performed.

The bright area image 55′ and the trajectory image 44′ can be matched in various ways other than aligning both the images first in the pipe-length direction of the main pipe and then in the circumferential direction thereof as shown in FIGS. 5 and 6. For example, aligning may be performed first in the circumferential direction and then in the pipe-length direction, or in the pipe-length and circumferential directions a plurality of times in small increments. In addition to visual matching on the display screen, matching can be performed by image processing as will be described in Embodiment 2.

Thus, the movement trajectory obtained when the laser spots rotate around the rotary shaft of the drilling blade approximately indicates a portion where the drilling blade actually cuts the pipe lining material. Since the drilling blade is positioned so that the trajectory image of the laser spots matches the bright area image corresponding to the lateral pipe opening, the drilling blade can be accurately moved to the position of the lateral pipe opening, allowing efficient drilling with few drilling errors.

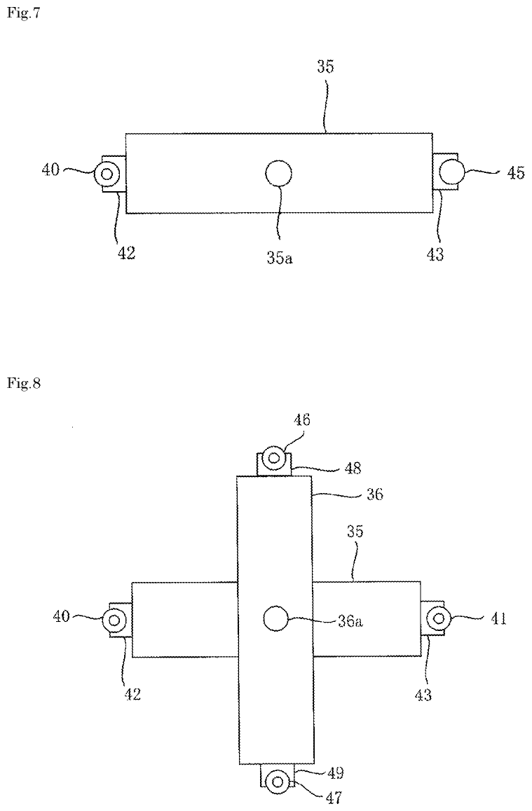

In the above-described embodiment, two laser light sources are provided 180 degrees apart in the circumferential direction of the drilling blade 30, but only one laser light source 40 may be provided as shown in FIG. 7. In this case, the trajectory image 44′ is not observed as a closed figure depending on the rotation speed of the electric motor 28, but it is easy to observe how far away from the bright area 55. Accordingly, the rotational speed of the electric motor 28 can be adjusted to a low speed so that the trajectory image can be easily observed on the screen of the display 60, or to a high speed so that the trajectory image 44 can be observed as a closed figure. When only one laser light source 40 is used, a counterbalance 45 is disposed where the laser light source 41 is located in order to balance the acting centrifugal force.

Conversely, a plurality of three or more laser light sources, for example, four laser light sources may be arranged at equiangular intervals of 90 degrees as shown in FIG. 8. In this case, laser light sources 46 and 47 are attached via holding brackets 48 and 49 to the holding plate 36 having the same shape as the holding plate 35. Both the holding plates 35 and 36 with the holes 35a and 36a aligned are fixed so as to be orthogonal to each other. As the number of laser light sources increases, the rotational speed of the electric motor 28 can be lowered, allowing the acting centrifugal force to be reduced.

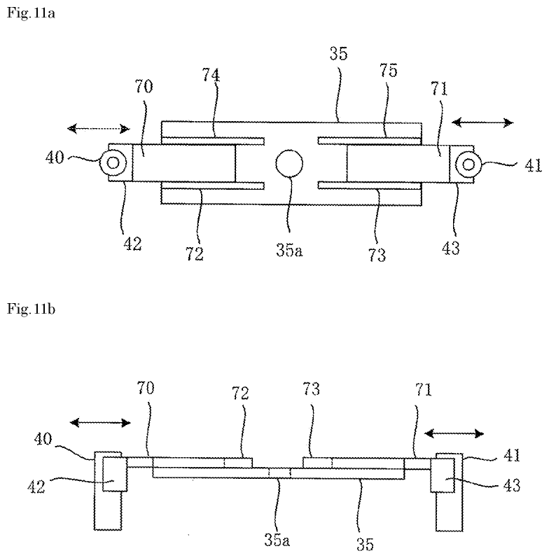

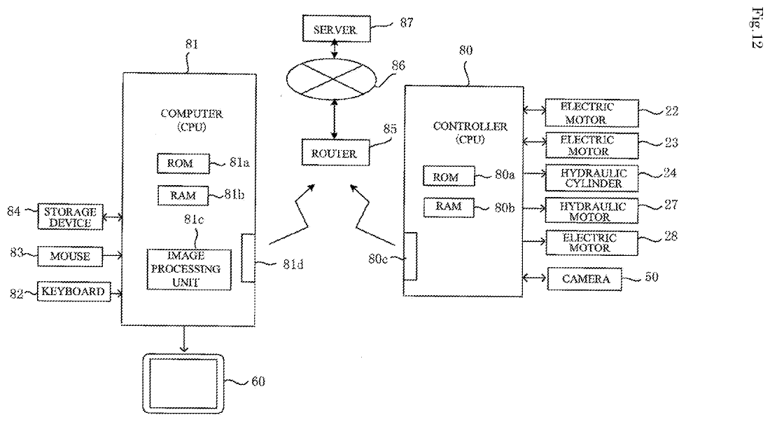

In order to grantee that the movement trajectory 44 of the laser spots 40b, 41b accurately indicate a portion where the drilling blade actually cuts the pipe lining material, it is preferable that laser beams 40a, 41a are, as shown in FIG. 2a, made close to the outer periphery of the drilling blade 30 to the extent that they are not blocked by the drilling blade. For safety reasons, a drilling blade with a smaller diameter than determined may be used. For this, as shown in FIGS. 11a and 11b, the laser light sources are made movable in the radial direction so as to enable the radial distance from the rotary shaft of the drilling blade to be adjusted.

In FIGS. 11a and 11b, the holding bracket 42 for holding the laser light source 40 is attached to a slide plate 70 that slides on the holding plate 35 along guide rails 72 and 74 mounted thereon. The holding bracket 43 for holding the laser light source 41 is attached to a slide plate 71 that slides on the holding plate 35 along guide rails 73 and 75 mounted thereon. The slide plates 70 and 71 are moved such that the radial distance of the laser light sources 40 and 41 from the rotary shaft of the drilling blade can be adjusted.

Since the radial distance of the laser light sources 40 and 41 relative to the drilling blade 30 can thus be adjusted, the laser light sources 40 and 41 can be disposed close to the limit where the laser beams 40a and 41a are not blocked by the drilling blade. As a result, the movement trajectory of the laser spots 40b and 41b accurately indicates the portion where the drilling blade actually cuts the pipe lining material. The laser light sources 40 and 41 can be disposed so that the laser beams 40a and 41a are projected on the outline of the bright area 55 corresponding to the lateral pipe opening or close to the inside thereof. This prevents the pipe lining material from being cut beyond the lateral pipe opening by the drilling blade and the lateral pipe opening from being damaged. After adjusting the positions of the laser light sources 40 and 41, the guide rails 72 to 75 and the slide plates 70 and 71 are tightened with bolts (not shown) to prevent the laser light sources 40 and 41 from moving.

In the above-mentioned embodiment, the hydraulic motor 27 for rotating the drilling blade 30 is made independent of the electric motor 28 for rotating the laser light sources 40, 41, 46, 47 in order to rotate the laser light sources independently of the drilling blade. However, the laser light sources and the drilling blade may be rotated simultaneously (or synchronously). In this case, the holding plate 35 is fixed to the output shaft 27a of the hydraulic motor 27, and the electric motor 28, the pinion gear 33, the gear 32, and the ring 31 are removed, as shown in FIG. 9.

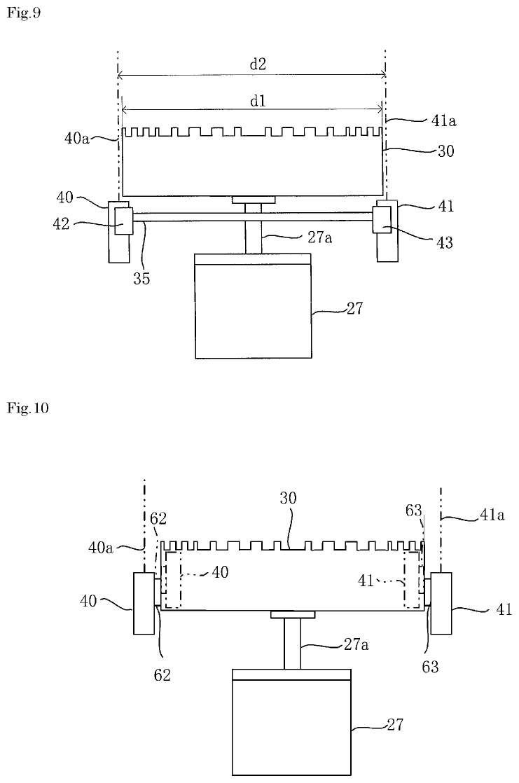

As shown in FIG. 10, the laser light sources 40 and 41 may be detachably attached via magnets 62, 63 to the outer circumferential surface of the drilling blade 30 so that the laser beams 40a and 41a are parallel to the rotary shaft of the drilling blade 30, that is, the rotary shaft 27a of the hydraulic motor 27. Even in this case, the laser spots produce the trajectory 44 when the drilling blade 30 is rotated. This allows the same effect to be obtained with a simple configuration. In the embodiment in FIGS. 9 and 10, the number of laser light sources can also be one or more. Furthermore, in the embodiment shown in FIG. 10, the laser light sources 40 and 41 may be attached to the inner circumferential surface of the drilling blade 30 as indicated by phantom lines instead of being attached to the outer circumferential surface thereof. In this case, the centrifugal force acting on the laser light sources 40 and 41 in accordance with rotation of the drilling blade 30 acts as a force that presses the laser light sources 40 and 41 against the inner circumferential surface of the drilling blade 30, allowing the laser light sources 40, 41 to be attached more reliably.

The hydraulic motor 27 can be an electric motor, and the electric motor 28 can be a hydraulic motor.

In the above-described embodiment, the drilling blade 30 is a hole saw having a cylindrical shape and having a bit at the upper end, but may be a hole saw having a center drill at the center. Further, it may be a drilling blade having a cylindrical shape and having a bit on the peripheral surface, or a conical hole saw having a bit on the peripheral surface.

The camera 50 is preferably capable of wide-angle photographing, and its mounting position is not limited to the robot 21, but a position where an image as shown in FIGS. 5 and 6 can be captured, for example, a position on the upper part of the mount 25 of the hydraulic cylinder 24. Furthermore, the mounting angle of the camera 50 can be adjusted to adjust the angle of the photographing optical axis relative to the horizontal direction, or a zoom mechanism can be provided to enable zoom photographing.

In the above-described embodiments, the pipe lining material is a visible light transmissive lining material. However, there are lining materials that are so thick that observing clear bright area is made difficult or lining materials made of materials such as vinyl chloride that do not transmit light. Even in such a case, the trajectory of the laser spot drawn on the inner circumferential surface of the pipe lining material indicates which part of the pipe lining material is drilled by what size. This would be useful for drilling the pipe lining material.

### Embodiment 2

In Embodiment 1, the drilling blade was manually moved in the pipe-length direction or in the circumferential direction to match the trajectory image of the laser spot with the bright area image of the lateral pipe opening. FIGS. 12 to 14 show an embodiment in which both images are automatically or semi-automatically matched.

In FIG. 12, a controller 80 having a CPU is mounted on the robot 21 and includes a ROM 80a for storing fixed data, programs and the like and a RAM 80b for storing control programs, processing data, temporary data and the like. As will be described later, the controller 80 is connected to the Internet and can function as a Web server.

The controller 80 receives commands from the computer 81 and other Web clients, drives the electric motors 22, 23, the hydraulic cylinder 24, the hydraulic motor 27 and the electric motor 28, and operates the camera 50. Since the electric motors 22, 23 are provided with a rotary encoder, the number of rotations (rotational speed) of the electric motors 22 and 23 is input to the controller 80, and photographed image data is also input thereto from the camera 50.

The computer 81 includes a CPU for performing operations and controls, a ROM 81a for storing basic programs, a RAM 81b for storing work data, processing data, a control program according to the present invention and the like, and an image processing unit 81c for processing images taken by the camera 50. The computer 81 is mounted on the work truck 14 and can issue various commands. Connected to the computer 81 are a keyboard 82 as an operation device, a mouse 83, a storage device 84 for storing a control program, and a display 60 for displaying a photographed image from the camera 50 or an image processed by the image processing unit 81c.

The controller 80 and the computer 81 are respectively provided with a communication function and are connected to the router 85 wirelessly via communication interfaces 80c and 81d to constitute a LAN. Since the router 85 is connected to the Internet 86, the controller 80 and the computer 81 can not only communicate with each other for data transmission, but also access an external server 87 connected to the Internet 86 to acquire the data stored therein, or to store the data acquired by the controller 80 or the computer 81 to the server 87.

So-called IoT (Internet of Things) that can control the controller 80 and the computer 81 from the server 87 can also be provided. The controller 80 can function as a Web server, and devices connected to the controller 80 can also be controlled using a Web browser.

The router 85 is disposed in the work truck 14 or at the bottom of the manhole 16, but when wireless communication is difficult, a router can be added or a repeater can be installed in the main pipe. Lan cables can also be used for wired communication to connect the router 85 to the controller 80 and the computer 81 and connect the controller 80 to the computer 81.

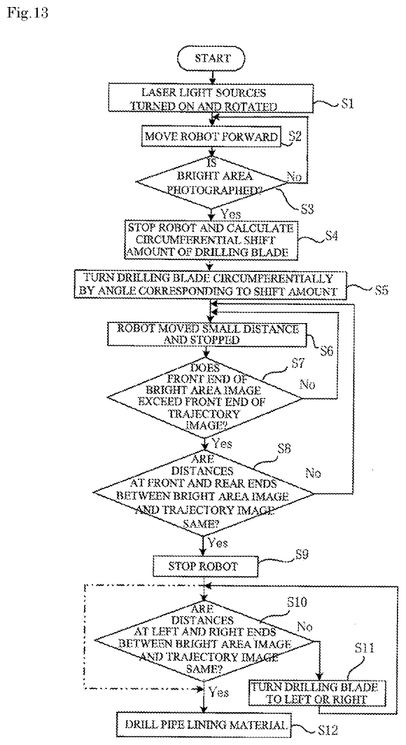

With such a configuration, the drilling blade 30 is positioned using the controller 80 by a control program stored in the computer 81. This positioning flow is illustrated in FIG. 13.

The robot 21 is first carried into the main pipe 11 from the manhole 16. The laser light sources 40, 41 are then turned on and rotated (step S1) and the robot 21 is moved forward (step S2). As the laser light sources 40 and 41 rotate, a movement trajectory 44 by the laser spots 40b and 41b is drawn on the inner circumferential surface of the pipe lining material 13 and is photographed by the camera 50. The captured image is transmitted to the computer 81, stored in the RAM 81b and displayed on the display 60 as videos.

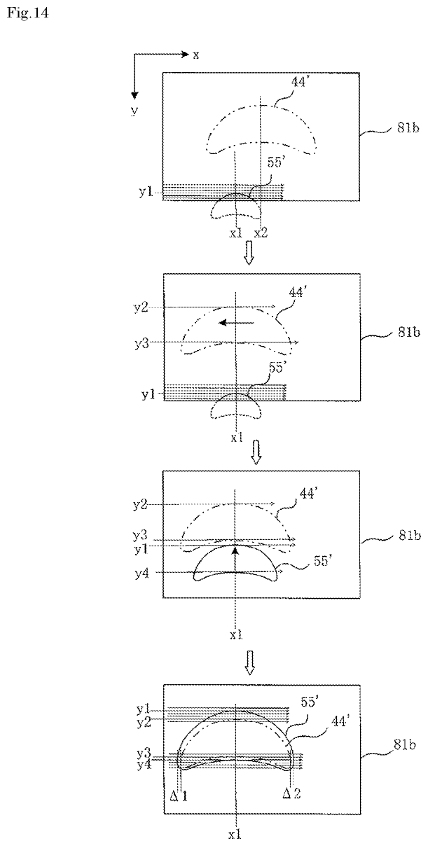

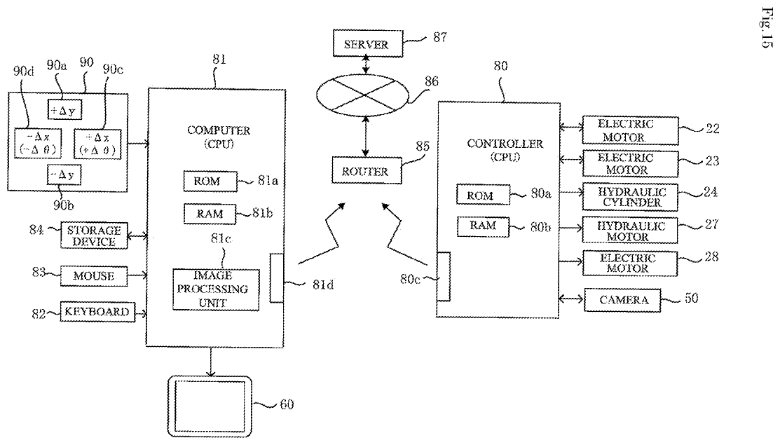

Since the pipe lining material 13 diffuses the projected laser spot, its diameter becomes larger than the diameter corresponding to the cross-sectional area of the laser beam. The image processing unit 81c captures the laser spot image at a predetermined sampling speed and extracts the center pixel of the spot image. After the laser spots 40b and 41b have rotated, for example, once, the image processing unit 81c connects the extracted central pixels to create the trajectory image 44′ of the laser spots in the image area of the RAM 81b as shown in the upper part of FIG. 14. In this manner, the image processing allows a still and clear trajectory image to be created. In principle, the trajectory image 44′ does not change even if the robot 21 moves, but the above-described processing is performed every predetermined time to update the trajectory image 44′.

When the robot 21 approaches the lateral pipe opening 12a, the camera 50 photographs the bright area 55 to capture the leading portion of the bright area image 55′ into the image area of the RAM 81b. The image processing unit 81c performs line scanning to detect the bright area image 55′ in the lower part. At this time, it is determined that the bright area 55 has been photographed (Yes in step S3), and the robot 21 is caused to stop (step S4). In step S4, the tip x-coordinate value x1 of the bright area image 55′ and the tip x-coordinate value x2 of the trajectory image 44′ at the time the robot 21 is stopped are acquired to calculate the shift amount (x1-2).

This shift amount is a negative value, which indicates that the robot 21 is rolled clockwise about the pipe axis 11a, so that the drilling blade 30 is turned counterclockwise about the rotary shaft 23a of the electric motor 23 by an angle corresponding to the shift amount (x1-2) (step S5). Once the drilling blade 30 is turned, the trajectory image 44′ is created in which the tip has moved to x1 from the photographed image, as shown in the second row of FIG. 14.

Subsequently, the robot 21 is moved forward by a small distance at a low speed, and the robot 21 is stopped (step S6). The front end y-coordinate value y1 and the rear end y-coordinate value y4 at x1 of the bright area image 55′ captured when the robot is stopped are acquired, and the front end y-coordinate value y2 and the rear end y-coordinate value y3 at x1 of the trajectory image 44′ are also acquired. The bright area image 55′ enlarges as the robot 21 advances, and the leading end of the bright area image 55′ exceeds the leading end of the trajectory image 44′ to become yl>y2 as shown in the lower part of FIG. 14. Until then, the loop of steps S6 and S7 is repeated.

When y1>y2, the trajectory image 44′ is positioned inside the bright area image 55′, so that the distance (y1-y2) at the front end between the bright area image 55′ and the trajectory image 44′ and the distance (y3-y4) at the rear end therebetween are acquired. The processes in steps S6 to S8 are repeated until the distances are the same. However, the photographing optical axis of the camera 50 is tilted, so that the distance (y3-y4) between the two images on the far side as viewed in the traveling direction is shorter than the distance (y1-y2) on the near side even if the actual distances are the same. Therefore, corrections are correspondingly made for distance comparison.

As described above, the bright area 55 formed on the inner circumferential surface of the pipe lining material diffuses when the illumination light from the lateral pipe side passes through the pipe lining material, so that its contour becomes unclear. In addition, there are cases where the lateral opening is damaged, or dirt accumulates to make the outline of the bright area 55 distorted or lost. For this, the image processing unit 81c performs contour extraction processing by a known method to clarify the contour of the bright area image and correct the distorted contour. If the contour is missing, the complemented image is stored as a bright area image 55′ for comparison with the trajectory image 44′.

If it is determined that the distances at the front and rear ends between the bright area image 55′ and the trajectory image 44′ are equal (Yes in step S8), the robot 21 is stopped (step S9). Note that there is a possibility that the rear end of the bright area image 55′ exceeds the rear end of the trajectory image 44′ to become y4>y3. In this case, the robot is moved backward in step S6 by a small distance for determination in step S8. In this way, the trajectory image 44′ matches the bright area image 55′, and the drilling blade 30 is positioned in the pipe-length direction and in the circumferential direction, so that the process proceeds to step 12 to allow drilling to start, as shown by the phantom line.

However, at the time of positioning in the pipe-length direction, the robot 21 repeatedly moves and stops several times in the pipe-length direction (step S6). This may cause the posture of the robot 21 to change. Furthermore, there is a possibility that the positioning is inaccurate when positioning in the circumferential direction in step S5.

Accordingly, in the state where the positioning in the pipe-length direction is completed as shown in the lower part of FIG. 14, the distances Δ1 and Δ2 at the left and right ends between the bright area image 55′ and the trajectory image 44′ are acquired, and the drilling blade 30 is rotated clockwise or counterclockwise for re-positioning in the circumferential direction until the distances Δ1 and Δ2 become equal (steps S10 and S11). Thus, the positioning of the drilling blade in the pipe-length direction and in the circumferential direction is completed, so that the process moves to step 12 to start drilling the pipe lining material.

In order to finely position the drilling blade 30, an operation panel 90 provided with operation buttons 90a to 90d may be connected to the computer 81 as shown in FIG. 15. When the operation button 90a is pressed once, the controller 80 rotates the electric motor 22 in the forward direction to advance the drilling blade 30 by Δy, and when the operation button 90b is pressed once, the electric motor 22 is rotated in the reverse direction to retract the drilling blade 30 Δy. When the operation button 90c is pressed once, the controller 80 rotates the electric motor 23 by Δθ clockwise to move the drilling blade 30 Δx to the right in the circumferential direction, and when the operation button 90d is pressed once, the electric motor 23 is rotated counterclockwise by Δθ to move the drilling blade 30 Δx to the left in the circumferential direction.

Each time the operation buttons 90a to 90d are pressed, the drilling blade 30 moves by a minute amount Δ in the corresponding direction. This allows the positions of the drilling blade 30 in circumferential and the pipe-length directions to be finely adjusted, making it possible to accurately match the bright area image and the trajectory image.

In the above-described embodiment, the bright area image 55′ and the trajectory image 44′ are first aligned in the circumferential direction and then both images are aligned in the pipe axis direction of the main tube. Both the images may be aligned first in the pipe-length direction and then in the circumferential direction.

The movement of the robot 21 in the pipe-length direction and the turning of the drilling blade 30 are performed by the electric motors 22 and 23 having a rotational position sensor such as a rotary encoder, so that the positioning accuracy can be improved.

Thus, in Embodiment 2, the drilling blade 30 is positioned with high accuracy in the pipe-length direction and in the circumferential direction so that the trajectory image 44′ may match the bright area image 55′ by program control. This allows efficient drilling with few drilling errors.

In Embodiment 2, the drilling apparatus is connected to the Internet, so that it is possible to control the drilling from an external server, or it is possible to store data such as a drilling location, a drilling supplier and a drilling date in the server 87 with a drilling image attached thereto. This helps for repairs and maintenance at a later date.

In Embodiment 2, as in Embodiment 1, one or a plurality of three or more laser light sources can be used, and the radial distance of each laser light source from the rotary shaft of the drilling blade can also be adjusted. Furthermore, the rotation of the laser light source is made independent of the rotation of the drilling blade, but it can also be rotated simultaneously.

As in Embodiment 1, the laser light source can be detachably attached to the outer circumferential surface or inner circumferential surface of the drilling blade via a magnet or the like. Various drilling blades as described in Embodiment 1 can also be used.

### KEY TO THE SYMBOLS

11 main pipe

12 lateral pipe

12a lateral pipe opening

13 pipe lining material

14 work truck

15 cable pipe

16 manhole

20 drilling apparatus

21 robot

22, 23 electric motor

24 hydraulic cylinder

27 hydraulic motor

28 electric motor

29 mount base

30 drilling blade

35, 36 holding plate

40, 41, 46, 47 laser light source

40a, 41a laser beam

40b, 41b laser spot

42, 43, 48, 49 holding bracket

44 movement trajectory of laser spot

44′ trajectory image

45 counterbalance

50 camera

51 bracing member

52 lighting lamp

55 bright area

55′ bright area image

60 display

62, 63 magnet

70, 71 slide plate

72 to 75 guide rail

80 controller

81 computer

1. A drilling apparatus in which a pipe lining material that blocks a lateral pipe opening is drilled from the main pipe side by rotating a drilling blade comprising:
a robot that moves in the pipe-length direction inside the main pipe;
a drilling blade mounted on the robot;
a motor for rotating the drilling blade;
a laser light source disposed in the vicinity of the drilling blade for emitting a laser beam parallel to the rotary shaft of the drilling blade to form a laser spot on the inner circumferential surface of the pipe lining material;
a camera mounted on the robot for photographing a trajectory of the laser spot that is drawn on the inner circumferential surface of the pipe lining material by rotating the laser light source coaxially with the rotary shaft of the drilling blade, and a bright area corresponding to the lateral pipe opening that is formed on the inner circumferential surface of the pipe lining material by illumination light from the lateral pipe side; and
positioning means for positioning the drilling blade so that the trajectory image of the laser spot photographed by the camera matches the bright area image corresponding to the lateral pipe opening.

2. A drilling apparatus according to claim 1, wherein the laser light source is rotated independently of the drilling blade.

3. A drilling apparatus according to claim 1, wherein the laser light source is disposed close to the outer periphery of the drilling blade to the limit that the emitted laser beam is not blocked by the drilling blade.

4. A drilling apparatus according to claim 1, wherein the laser light source is attached to the outer peripheral surface or inner peripheral surface of the drilling blade so that the laser beam is parallel to the rotary shaft of the drilling blade.

5. A drilling method in which a pipe lining material that blocks a lateral pipe opening is drilled from the main pipe side by rotating a drilling blade comprising:
illuminating the lateral pipe opening from the lateral pipe side;
emitting a laser beam from a laser light source toward the pipe lining material in a direction parallel to the rotary shaft of the drilling blade from a position near the drilling blade to form a laser spot on the inner circumferential surface of the pipe lining material;
moving the drilling blade to the position of a bright area corresponding to the lateral pipe opening that is formed on the inner circumferential surface of the pipe lining material by illumination light from the lateral pipe side while rotating the laser light source coaxially with the rotary shaft of the drilling blade;
photographing the trajectory of the laser spot that is drawn on the inner circumferential surface of the pipe lining material in accordance with rotation of the laser light source and the bright area corresponding to the lateral pipe opening; and
drilling by positioning the drilling blade so that the trajectory image of the photographed laser spot matches the bright area image corresponding to the lateral pipe opening.

6. A drilling method according to claim 5, wherein the positioning of the drilling blade is performed in the pipe-length direction and in the circumferential direction of the main pipe.

7. A drilling method according to claim 5, wherein the laser light source is rotated independently of the drilling blade.

8. A drilling method according to claim 5, wherein the laser light source is disposed close to the outer periphery of the drilling blade to the limit that the emitted laser beam is not blocked by the drilling blade.

9. A drilling method according to claim 5, wherein the laser light source is attached to the outer peripheral surface or inner peripheral surface of the drilling blade so that the laser beam is parallel to the rotary shaft of the drilling blade.
